(19) United States
(12) Patent Application Publication
(10) Pub. No.: US 2024/0196901 A1
(43) Pub. Date: Jun. 20, 2024

(54) Zinc and Boron Containing Enhanced Wood Preservative

(71) Applicant: ARXADA, LLC, Morristown, NJ (US)

(72) Inventors: Ed Nichenko, McDonough, GA (US); Jayesh Patel, Stone Mountain, GA (US); Susan Thomason, Oxford, GA (US); Jin Lehong, Huntersville, NC (US)

(21) Appl. No.: 18/551,218

(22) PCT Filed: Mar. 18, 2022
(86) PCT No.: PCT/US2022/020961

§ 371 Date: Sep. 19, 2023

Related U.S. Application Data
(60) Provisional application No. 63/166,733, filed on Mar. 26, 2021.
(60) Provisional application No. 63/163,219, filed on Mar. 19, 2021.

(30) Foreign Application Priority Data
Apr. 20, 2021 (EP) 21169455.9

(51) Int. Cl. A01N 59/20; A01N 43/56; A01N 43/653; A01N 59/14; A01N 59/16; A01P 3/00; B27K 3/00; B27K 3/16; B27K 3/22; B27K 3/34; B27K 3/52

(52) U.S. Cl. CPC A01N 59/20; A01N 43/56; A01N 43/653; A01N 59/14; A01N 59/16; A01P 3/00; B27K 3/005; B27K 3/163; B27K 3/22; B27K 3/343; B27K 3/52; B27K 2240/20

(57) ABSTRACT

A wood preservative composition and a method of manufacturing a wood preservative composition that includes a copper containing biocide, a zinc containing biocide, a boron containing biocide, and an azole are provided. The wood preservative composition exhibits improved biocidal efficacy against copper tolerant fungi.

### RELATED APPLICATIONS

The present application is based on and claims priority to U.S. Provisional Patent application Ser. No. 63/163,219, filed on Mar. 19, 2021, and to Ser. No. 63/166,733, filed on Mar. 26, 2021, which are both incorporated herein by reference.

### BACKGROUND

Timber based products are subject to attack from various types of organisms, including molds, fungi, and insects, such as termites. Attacks by these organisms can cause the timber in timber based products to decay, reducing the product's mass and structural integrity. In order to combat microorganism attack, many types of wood preservative treatments have been developed and exist on the market today. These wood preservative treatments can be applied directly to the surface, by dip, spray or brush, or by vacuum pressure immersion. During industrial application of preservatives, timber is typically impregnated with the treatment solution to achieve either shell or full cell type penetration into the substrate. Depending on the wood species being treated and the end use, the depth of penetration of the preservative solution into the timber can have a significant bearing on the useful service life of the treated timber.

Copper-organic wood preservatives have been used successfully as ground contact preservatives around the world. However, there are fungi which have proved resistant to such formulations, and cause staining and degradation of wood containing copper based preservatives. Other types of biocidal metal ions can also be used to treat wood, such as zinc. Although perhaps not as widespread in its use as copper, there are a number of commercially available wood preservatives which include zinc as a biocidal metal ion, either alone or in combination with copper. However, these existing formulations suffer from either (1) the zinc failing to properly control the copper resistant fungi, or (2) lacking sufficient efficacy against even non-copper resistant fungi when used together at the same active amount as copper alone, in addition to other problems.

Non-metal based alternatives such as azoles and boron based biocides have been used in combination with metal based preservatives in order to combat metal-tolerant fungi. However, azoles and boron based biocides, alone or in combination were found to demonstrate drawbacks, including leachability.

Accordingly, there is a need for wood preservative compositions that offer enhanced biocidal efficacy. It would be a further benefit to provide a wood preservative composition that exhibits improved efficacy against copper tolerant fungi. Furthermore, it would be a benefit to provide a biocidal composition that exhibits prolonged efficacy against fungi, including copper-tolerant fungi.

### SUMMARY

In general, the present disclosure is directed to a wood preservative composition. The wood preservative composition exhibits improved biocidal efficacy against copper tolerant fungi.

In a first example embodiment, the wood preservative composition includes a copper containing biocide, a zinc containing biocide, a boron containing biocide, and an azole. The boron containing biocide includes boric acid, disodium tetraborate pentahydrate, disodium octoborate tetrahydrate, or combinations thereof. The copper containing biocide and the zinc containing biocide are present in the wood preservative composition such that a ratio of copper ions to zinc ions is from about 15:1 to about 1:5. Additionally, the copper containing biocide and the boron containing biocide are present in the wood preservative composition such that a ratio of copper ions to boric acid equivalents is from about 15:1 to about 1:5.

In a first example aspect, the copper containing biocide can include a basic copper carbonate, a copper oxide, or a combination thereof.

In a second example aspect, the zinc containing biocide can include a zinc oxide or a combination of zinc oxide and zinc borate.

In a third example aspect, the boron containing biocide can be boric acid.

In a fourth example aspect, the azole can include a tebuconazole, penflufen, or a mixture thereof.

In a fifth example aspect, the azole can include a tebuconazole, a propiconazole, or a mixture thereof.

In a sixth example aspect, the azole can be complexed with the copper containing biocide.

In a seventh example aspect, the azole can include micronized azole particles. 50% or more of the micronized azole particles can have a particle size of less than about 1 micron.

In an eighth example aspect, the copper containing biocide can include a basic copper carbonate, the zinc containing biocide can include a zinc oxide or a combination of a zinc oxide and zinc borate, the boron containing biocide can include a boric acid, and the azole can include a tebuconazole.

In a ninth example aspect, the copper containing biocide can constitute from about 0.1 wt. % to about 75 wt. % of the composition, the zinc containing biocide can constitute from about 0.1 wt. % to about 50 wt. % of the composition, the boron containing biocide can constitute from about 0.1 wt. % to about 75 wt. % of the composition, and the azole can constitute from about 0.1 wt. % to about 20 wt. % of the composition.

In a tenth example aspect, the composition can have a pH of from about 3 to about 10.

In an eleventh example aspect, the composition can further include an alkanolamine.

In a twelfth example aspect, the copper containing biocide and the zinc containing biocide can be present in the wood preservative composition such that a ratio of copper ions to zinc ions is from about 10:1 to about 2:1.

In a thirteenth example aspect, the copper containing biocide and the boron containing biocide can be present in the wood preservative composition such that a ratio of copper ions to boric acid equivalents is from about 10:1 to about 2:1.

In a fourteenth example aspect, the zinc containing biocide and the boron containing biocide can be present in the wood preservative composition such that a ratio of zinc ions to boric acid equivalents is from about 5:1 to about 1:5.

In a fifteenth example aspect, the zinc containing biocide and the boron containing biocide can be present in the wood preservative composition such that a ratio of zinc ions to boric acid equivalents is from about 3:1 to about 1:1.5.

In a sixteenth example aspect, a wood based product can be treated with any of the wood preservative compositions described.

In a seventeenth example aspect, a wood based product can be treated with any of the wood preservative composition described. In the wood based product, the copper ions can be present in an amount from about 200 grams per meter cubed (g/m³) to about 7.5 kg/m³, the zinc ions can be present in an amount from about 40 g/m³ to about 1.5 kg/m³, the boric acid equivalents can be present in an amount from about 40 g/m³ to about 3 kg/m³, and the azole can be present in an amount from about 20 g/m³ to about 260 g/m³ of the product.

In a second example embodiment, a wood preservative composition includes a copper containing biocide, a zinc containing biocide, a boron containing biocide including boric acid, and an azole. The copper containing biocide and the zinc containing biocide are present in the wood preservative composition such that a ratio of copper ions to zinc ions is from about 15:1 to about 1:1. The copper containing biocide and the boron containing biocide are present in the wood preservative composition such that a ratio of copper ions to boric acid equivalents is from about 15:1 to about 1:5. The copper containing biocide includes a basic copper carbonate. The zinc containing biocide comprises a zinc oxide or a combination of a zinc oxide and zinc borate. The boron containing biocide comprises a boric acid. The azole comprises a tebuconazole.

In an eighteenth example aspect, a method of treating wood with any of the wood preservative compositions disclosed is described. In the method, the copper containing biocide, the zinc containing biocide, the boron containing biocide, and the azole can be injected into the wood in a one-step process.

In a third example embodiment, a method for manufacturing a wood preservative composition is described. The method includes dispersing at least a portion of a copper containing biocide and a zinc containing biocide, micronizing at least one azole to produce a micronized azole, and combining a boron containing biocide including boric acid with the copper containing biocide, the zinc containing biocide, and the micronized azole. The copper containing biocide and the zinc containing biocide are present in the wood preservative composition such that a ratio of copper ions to zinc ions is from about 15:1 to about 1:5. Additionally, the copper containing biocide and the boron containing biocide are present in the wood preservative composition such that a ratio of copper ions to boric acid equivalents is from about 15:1 to about 1:5.

In a nineteenth example aspect, the copper containing biocide and the zinc containing biocide can be milled with at least one dispersant.

In a twentieth example aspect, the copper containing biocide can constitute from about 1 wt. % to about 75 wt. % of the composition, the zinc containing biocide can constitute from about 0.1 wt. % to about 50 wt. % of the composition, the boron containing biocide can constitute from about 0.1 wt. % to about 75 wt. % of the composition, and the azole can constitute from about 0.1 wt. % to about 20 wt. % of the composition.

In a twenty-first example aspect the copper containing biocide can include a basic copper carbonate, the zinc containing biocide can include a zinc oxide or a combination of a zinc oxide and a zinc borate, the boron containing biocide can include a boric acid, and the azole can include a tebuconazole.

Each of the example aspects recited above may be combined with one or more of the other example aspects recited above in certain embodiments. For instance, all of the seventeen example aspects recited above for the first example embodiment may be combined with one another in some embodiments. As another example, any combination of two, three, four, five, or more of the seventeen example aspects recited above for the first example embodiment may be combined in other embodiments. Thus, the respective example aspects recited above for each example embodiment may be utilized in combination with one another in some example embodiments. Alternatively, the respective example aspects recited above for each example embodiment may be individually implemented in other example embodiments. Accordingly, it will be understood that various example embodiments may be realized utilizing the example aspects recited above.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### DEFINITIONS

As used herein, the term “D50” or “D50 particle size” refers to the volume median particle size, where 50% of the particles of the sample volume have a size below that range or value.

As used herein, the term “D10” or “D10 particle size” refers to the volume median particle size, where 10% of the particles of the sample volume have a size below that range or value.

As used herein, the term “D50” or “D50 particle size” refers to the volume median particle size, where 50% of the particles of the sample volume have a size below that range or value.

Analogously, as used herein, the term “D90” or “D90 particle size” refers to a value where 90% of the particles of the sample volume have a size below that range or value.

Analogously, as used herein, the term “D99” or “D99 particle size” refers to a value where 99% of the particles of the sample volume have a size below that range or value.

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

### DETAILED DESCRIPTION

Generally speaking, the present disclosure is directed to an unexpectedly synergistic combination of a biocidal metal (copper), a biocidal zinc, at least one azole, and a boron containing biocide that provides a highly effective wood preservation formulation. Surprisingly, the formulations prepared by the present disclosure display significant synergy between the active components which provide for improved biocidal efficacy against copper tolerant fungi even at the same, or similar total metal-based biocide concentrations. Additionally, the present disclosure has found that, when the disclosed formulations are utilized in the treatment of timber, the resulting timber based product exhibits improved properties over copper tolerant fungi, as well as improved longer term protection, both in the core and outer layers of the timber based product.

Particularly, the present disclosure has found that by incorporating specific amounts of a boron containing biocide and a zinc containing biocide in relation to the biocidal metal (copper), a synergistic effect can be exhibited, combatting fungi, including copper tolerant fungi, resulting in more robust preservation, as well as longer term preservation, than previously exhibited by a biocide containing any one or more of the above components alone, or in amounts outside of the ratios of the present disclosure. For instance, the copper containing biocide and the zinc containing biocide may be present in the preservative composition in an amount such that a ratio of copper ions to zinc ions of about 15:1 to about 1:5 is provided in the preservative composition, such as about 12.5:1 to about 1:1, such as about 10:1 to about 3:1, such as about 9:1 to about 4:1, such as about 8:1 to about 5:1, or any ranges or values therebetween.

Similarly, the copper containing biocide and the boron containing biocide may be present in the preservative composition in an amount such that a ratio of copper ions to borate, expressed as boric acid equivalents, of about 15:1 to about 1:5 is provided in the preservative composition, about 15:1 to about 1:1, such as about 12.5:1 to about 1.5:1, such as about 10:1 to about 2:1, such as about 9:1 to about 3:1, such as about 8:1 to about 4:1, or any ranges or values therebetween. Particularly, as discussed above, the present disclosure has found that by supplementing the copper ions with zinc ions and boron containing biocide equivalents, excellent protection against fungi, including copper-tolerant fungi, is exhibited. Conversely, the present disclosure has found that if too little copper is present with the zinc and/or boron (e.g. a ratio of less than 1:5), insufficient preservation against certain copper tolerant fungi is exhibited, and no synergistic effect is shown. Similarly, if too little zinc and/or boron is present with the copper (e.g. a ratio of greater than 15:1), the composition exhibited poor preservation against certain copper tolerant fungi, and no synergistic effect was shown.

For instance, the present disclosure has found that the sum of the fractional inhibitory concentrations of the composition containing the copper containing biocide, zinc containing biocide, boron containing biocide, and azole in the above ratios may be less than 1 when tested against a target microorganism, particularly against brown rot fungi. The fractional inhibitory concentration is calculated as the concentration of a biocide which controlled growth in a mixture divided by the amount of biocide required to control growth when used alone. Particularly, here, the fractional inhibitory concentration is calculated against an amount of a composition containing copper and azole alone needed to control growth of a copper resistant fungi, Fibroporia radiculosa. The fractional inhibitory concentration of a biocide can be calculated by dividing the concentration of the biocide attributable to antimicrobial activity in a mixture of the copper containing biocide, zinc containing biocide, boron containing biocide, and azole divided by the minimum inhibitory concentration of the combination of copper containing biocide and azole when tested against the target microorganism. The minimum inhibitory concentration is the lowest concentration of biocide which showed growth inhibition when used alone. In accordance with the present disclosure, when targeting a particular microorganism, the sum of the fractional inhibitory concentrations of the first biocide and the second biocide, when used in combination with the zinc and boron can be less than about 0.9, such as less than about 0.8, such as less than about 0.7, which will be discussed in greater detail in the examples below. As known in the art, any value less than 1 indicates synergistic interactions.

Nonetheless, in one aspect, while the copper containing biocide can include any biocidal copper compound providing the above recited ratio of copper ions, the copper containing biocide may be incorporated into the formulation in the form of inorganic copper salts, such as carbonate, bicarbonate, sulphate, nitrate, chloride, hydroxide, borate, fluoride or oxide. Alternatively, the copper may be in the form of a simple organic salt, such as formate or acetate, or as a complex such as N-nitroso-N-cyclohexyl-hydroxylamine-copper (copper-HDO) or copper pyrithione (bis(2-pyridylthio)copper 1,1′-dioxide, CAS number 14915-37-8). Other examples of the copper containing biocide include copper sulfates, such as basic copper sulfate and copper sulfate pentahydrate, copper oxides, such as cuprous oxide and cupric oxide, and copper salts, such as copper salts of fatty and rosin acids, copper ethylenediamine complex, copper triethanolamine complex, copper ethylenediaminetetraacetate, and copper thiocyanate. Still other examples of the copper containing biocide include copper octanoate, copper diammonia diacetate complex, copper ethanolamine complex, copper naphthenate, and copper 8-quinolinoate.

In one aspect, the biocidal copper ion is a copper (II) ion. For instance, forms of copper (II) include basic copper chloride, basic copper carbonate (CuCO₃·Cu(OH)₂), copper (II) acetate, copper ammonium carbonate complex, copper (II) hydroxide, copper (II) oxide, copper oxychloride, copper oxychloride sulfate, copper ammonium complex, chelates of copper citrate, chelates of copper gluconate, and copper (II) sulphate pentahydrate, and, in an aspect, the copper containing biocide is basic copper carbonate or copper oxide. However, in one aspect, the copper compounds that are used are copper oxide and copper carbonate, such as basic copper carbonate.

In example embodiments, the copper containing biocide may include one or more soluble copper biocides. For instance, the copper containing biocide may include or be present as copper ethanolamine, copper ammonium complexes, or mixtures thereof.

Notwithstanding the form of the copper containing biocide, the copper containing biocide may be present in the composition such that copper ions form about 1% to about 75% by weight of the composition, such as about 1% to about 50%, such as about 2% to about 50%, such as about 3% to about 40%, such as about 4% to about 35%, such as about 5% to about 32.5%, such as about 6% to about 30%, such as about 7.5% to about 27.5% by weight of the composition, or any ranges or values therebetween.

Moreover, notwithstanding in the type or amount of copper containing biocide(s) selected, the copper containing biocide may be present in micronized form, alone or in combination with a dispersing agent. For instance, in an aspect, the copper particles have a size of about 10 microns or less, such as about 8 microns or less, such as about 6 microns or less, such as about 5 microns or less, such as about 4 microns or less, such as about 3 microns or less, such as about 2 microns or less, such as about 1 micron or less. Additionally or alternatively, at least about 10% or more of the copper particles have a size of about 1 micron or less, such as about 25% or more, such as about 50% or more, such as about 60% or more, such as about 70% or more, such as about 80% or more, such as about 90% or more, such as about 95% or more. Furthermore, the copper containing biocide may have a D10, D50, D90, or D99 particle size below any one or more of the above ranges. Furthermore, as will be discussed in greater detail below, in a further aspect, the azole, zinc, boron, or combinations thereof may also be micronized, having particle sizes according to one or more of the above.

Moreover, the zinc containing biocide may be any zinc containing biocide generally employed in the art. For instance, the zinc containing biocide may be a zinc alloy, a zinc salt, a zinc oxide, a zinc hydroxide, zinc ammonium complex, or a combination thereof. In one aspect, the zinc salt may be a zinc salt of an organic acid and/or a zinc salt of an inorganic acid. In this regard, the zinc containing biocide may be a zinc alloy, a zinc salt of an organic acid, a zinc salt of an inorganic acid, a zinc oxide, a zinc hydroxide, or a combination thereof.

In one aspect, the zinc containing biocide may comprise a zinc salt, such as a zinc salt of an organic acid, an inorganic acid, or a combination thereof. In another aspect, the zinc containing biocide may comprise zinc oxide, a zinc hydroxide, or a combination thereof.

In general, zinc salts include, but are not limited to, zinc acetate, zinc borate, zinc carbonate, basic zinc carbonate, zinc chloride, zinc sulfate, zinc citrate, zinc fluoride, zinc iodide, zinc lactate, zinc oleate, zinc oxalate, zinc phosphate, zinc propionate, zinc salicylate, zinc selenate, zinc silicate, zinc stearate, zinc sulfide, zinc sulfate, zinc tannate, zinc tartrate, zinc valerate, or any combination thereof.

In one embodiment, the zinc containing biocide may be a binary zinc containing biocide. For instance, the binary zinc containing biocide may be zinc oxide, zinc sulfide, zinc halide (e.g., zinc fluoride, zinc iodide, zinc chloride, zinc bromide), zinc peroxide, zinc hydride, zinc carbide, zinc nitride, etc., or any combination thereof. In one particular embodiment, the binary zinc containing biocide may be a zinc halide, such as a zinc chloride. Nonetheless, in one aspect, the zinc containing biocide may be a zinc oxide, a zinc borate, or a combination thereof. Also, it should be understood that the aforementioned zinc containing biocides may be used individually or in any combination.

In one aspect, the zinc containing biocide may include zinc pyrithione.

However, it should be understood that, and as will be discussed in greater detail below, zinc borate does not provide the requisite ratio of zinc or boric acid equivalents to the preservative composition. Particularly, zinc borate alone fails to provide enough zinc to form the copper ion to zinc ion ratios of the present disclosure while maintaining the ratios of copper ion to boric acid equivalents. Thus, in one aspect, while zinc borate is used, a further, or second zinc compound is used in conjunction with the zinc borate.

Furthermore, notwithstanding the zinc containing biocide selected, the zinc containing biocide may be present in the composition such that zinc ions form about 0.01% to about 50% by weight of the composition, such as about 0.1% to about 45%, such as about 0.25% to about 40%, such as about 0.5% to about 35%, such as about 0.75% to about 32.5%, such as about 1% to about 30%, such as about 1.5% to about 27.5% by weight of the composition, or any ranges or values therebetween.

In one aspect, the boron containing biocide can include a variety of borates, including soluble and insoluble borates, boron containing acids, oxide, salt, or combinations thereof. Such as, in one aspect, metal borates, borate minerals, borate esters, and other inorganic or organic borates. In one aspect, the boron containing biocide can include boric oxides, boric acid, salts of boric acid, or combinations thereof. Particularly, in an aspect, the boron containing biocide can include boric oxide, boric acid, sodium borate, calcium borate, magnesium borate, zinc borate, disodium octoborate tetrahydrate, copper borate, silicate borates, or combinations thereof. Further, in one aspect, the boron containing biocide is boric acid, disodium octoborate tetrahydrate, disodium tetraborate pentahydrate, or a combination thereof. However, in an aspect, the boron containing biocide may also be micronized, and have any one or more of the particle sizes discussed herein.

Nonetheless, the boron containing biocide may be present in the composition such that boron ions form about 0.01% to about 75% by weight of the composition, such as about 0.1% to about 70%, such as about 0.25% to about 65%, such as about 0.5% to about 60%, such as about 0.75% to about 57.5%, such as about 1% to about 55%, such as about 1.5% to about 52.5% by weight of the composition, or any ranges or values therebetween.

As discussed above, the preservative composition further includes at least one azole, i.e. a compound comprising an azole group. The azole may be an imidazole or a 1,2,4-triazole, or, in an aspect, a pyrazole, such as penflufen. Nonetheless, in an aspect, the azole can be represented by the general formula (III)

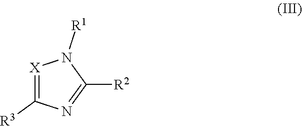

where:
X denotes CR⁴ or N,
R¹ denotes hydrogen or a linear, branched, cyclic, aromatic or any combination thereof, saturated or unsaturated, substituted or unsubstituted C₁ to C₄₀ group, any of the carbon atoms other than those bound to the nitrogen atom shown in formula (IV) may be replaced with an optionally substituted hetero atom;
R² denotes hydrogen, C₁-C₈ alkyl, C₂-C₈ alkenyl, C₆-C₁₀ aromatic, C₅-C₁₀ heteroaromatic or C₁-C₄ alkyl carbamate; and
R³ and R⁴ denote hydrogen; or
together R³ and R⁴ may provide a benzimidazole group (i.e. R³ and R⁴ may combine to form —(CH)₄—).

The preservative composition of the present disclosure may contain one or more azole compounds, such as mixtures of an imidazole and a 1,2,4-triazole, or mixtures of two or more 1,2,4-triazoles. Using a mixture of azoles may allow a broader range of activity against fungi in some aspects. However, in one aspect, the preservative composition of the present disclosure utilizes one or more 1,2,4-triazole(s) alone or in combination with an imidazole.

The imidazole compound incorporates a five-membered diunsaturated ring composed of three carbon atoms and two nitrogen atoms at non-adjacent positions. The imidazole compound may be a benzimidazole. In one aspect, the azole can include thiabendazole, imazalil, carbendazim and prochloraz.

The 1,2,4-triazole compound incorporates a five-membered diunsaturated ring composed of three nitrogen atoms and two carbon atoms at non-adjacent positions.

In one aspect, triazole compounds include a triazole compound selected from compounds of formula (IV):

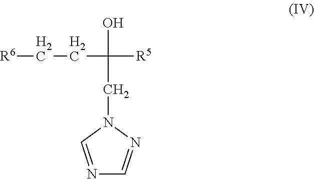

where R⁵ represents a branched or straight chain C₁₋₅ alkyl group (e.g. t-butyl) and R⁶ represents a phenyl group optionally substituted by one or more substituents selected from halogen (e.g. chlorine, fluorine or bromine) atoms or C₁₋₃ alkyl (e.g. methyl), C₁₋₃ alkoxy (e.g. methoxy), phenyl or nitro groups.

Alternatively, the triazole compound can be selected from compounds of formula (V):

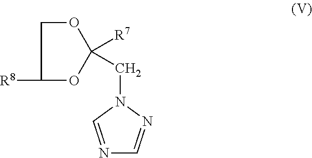

wherein R⁷ is as defined for R⁶ above and R⁸ represents a hydrogen atom or a branched or straight chain C₁₋₅ alkyl group (e.g. n-propyl).

Particularly, in one aspect, the azole can include one or more triazoles including, but not limited to, triadimefon, triadimenol, triazbutil, propiconazole, cyproconazole, difenoconazole, fluquinconazole, tebuconazole, flusilazole, uniconazole, diniconazole, bitertanol, hexaconazole, azaconazole, flutriafol, epoxyconazole, tetraconazole, penconazole, ipconazole, prothioconazole and mixtures thereof.

In a further aspect, triazoles include propiconazole, azaconazole, hexaconazole, tebuconazole, cyproconazole, triadimefon, ipconazole, prothioconazole and mixtures thereof, such as, in one aspect, propiconazole, tebuconazole, cyproconazole and mixtures thereof. Moreover, in an aspect, the azole includes propiconazole, tebuconazole, or mixtures thereof.

Furthermore, in one aspect, if a mixture of propiconazole and tebuconazole is utilized, propiconazole and tebuconazole are used in mixture in a ratio of propiconazole to tebuconazole of about 1:10 to about 10:1, such as about 1:5 to about 5:1, such as about 1:1 to 5:1, such as about 3:1 by weight, or any ranges or values therebetween.

Regardless of the azole or azoles selected, the azole may be present in the preservative composition in an amount of about 0.01% to about 20% by weight, such as about 0.1% to about 18%, such as about 0.25% to about 16%, such as about 0.5% to about 15%, such as about 0.75% to about 14%, such as about 0.9% to about 12.5% by weight of the composition, or any ranges or values therebetween

Moreover, notwithstanding in the type or amount of azole(s) selected, the azole may be present in micronized form, alone or in combination with a dispersing agent. For instance, in an aspect, the azole particles have a size of about 10 microns or less, such as about 8 microns or less, such as about 6 microns or less, such as about 5 microns or less, such as about 4 microns or less, such as about 3 microns or less, such as about 2 microns or less, such as about 1 micron or less. Additionally or alternatively, at least about 10% or more of the azole particles have a size of about 1 micron or less, such as about 25% or more, such as about 50% or more, such as about 60% or more, such as about 70% or more, such as about 80% or more, such as about 90% or more, such as about 95% or more.

Furthermore, in one aspect, the preservative composition may also include a dispersing agent and/or solvent. In one aspect, the dispersing agent and/or solvent is an alkanolamine, such as monoethanolamine, diethanolamine, triethanolamine, monopropanolamine, dipropanolamine, and tripropanolamine. In one aspect, the dispersing agent and/or solvent is an ethanolamine, such as monoethanolamine. However, it should be understood that other dispersing agents and/or solvents as known in the art may be used. As a particular example, the above recited dispersing agents and/or solvents may be a solvent for boric acid in certain example embodiments.

Additionally, or alternatively, the dispersing agent may be complexed with some or all of one or more components of the preservative formulation. For instance, in one aspect, the dispersing agent may be complexed with at least a portion of the azole, the copper containing biocide, or both the azole and the copper containing biocide. However, it should be understood that, in one aspect, at least a portion of the dispersing agent may be “free” in solution in the sense that at least a portion is not complexed with another component.

In one aspect, the above combination of azole, copper containing biocide, zinc containing biocide, and boron containing biocide may be used alone as a preservative composition. However, in one aspect, the preservative composition can include one or more further organic fungicidal timber decay preservatives other than the above. For instance, organic fungicidal timber decay preservatives suitable for use in the preservative composition of the present disclosure include fungicidal amides such as prochloraz, dichlofluanid and tolylfluanid; fungicidal aromatic compounds such as chlorthalonil, cresol, dicloran, pentachlorophenol, sodium pentachlorophenol, 2-(thiocyanatomethylthio)-1,3-benzothiazole (TCMBC), dichlorophen, fludioxonil and 8-hydroxyquinoline; fungicidal heterocyclic compounds such as dazomet, fenpropimorph, bethoxazin and dehydroacetic acid; strobilurins such as azoxystrobin; pyraclostrobin; fluazinam; quaternary ammonium compounds; isothiazolones; pyrithiones; and mixtures thereof.

In one aspect, organic fungicidal timber decay preservatives are selected from quaternary ammonium compounds, isothiazolones and fungicidal heterocyclic compounds such as fenpropimorph.

Quaternary ammonium compounds can include trimethyl alkyl quaternary ammonium compounds such as cocotrimethyl ammonium chloride; dialkyldimethyl quaternary ammonium compounds such as didecyl dimethyl ammonium chloride, didecyl dimethyl ammonium carbonate, didecyl dimethyl ammonium bicarbonate, dioctyl dimethyl ammonium chloride and octyl decyl dimethyl ammonium chloride, or mixtures thereof; alkyl dimethyl or diethyl benzyl ammonium salts such as benzalkonium chloride and benzalkonium hydroxide; polyethoxylated quaternary ammonium compounds such as N,N-didecyl-N-methyl-poly(oxyethyl) ammonium propionate (Bardap 26) or N,N-didecyl-N-methyl-poly(oxyethyl) ammonium lactate; and N-substituted pyridinium compounds such as cetyl pyridinium chloride. In one aspect, a quaternary ammonium compound can include benzalkonium chloride, didecyl dimethyl ammonium chloride and didecyl dimethyl ammonium carbonate.

In one aspect of the present disclosure, suitable isothiazolinones are represented by the general formula (I)

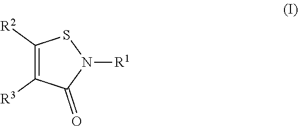

where: R¹ denotes hydrogen, optionally substituted C₁-C₁₈ alkyl, C₂-C₈ alkenyl or alkynyl, C₂-C₈ haloalkynyl, optionally substituted C₃-C₁₂ cycloalkyl, optionally substituted aralkyl having up to 10 carbon atoms, or optionally substituted aryl having up to 10 carbon atoms;
R² and R³ independently denote hydrogen, halogen or C₁-C₄ alkyl; or
together R² and R³ may provide a 1,2 benzisothiazolin-3-one group (i.e. R² and R³ may combine to form —(CH)₄—).

In one aspect, R² and R³ independently denote chloro or hydrogen, or together R² and R³ may provide a 1,2 benzisothiazolin-3-one group.

Thus, in an aspect, R¹ substituents are selected from hydrogen, methyl, ethyl, propyl, isopropyl, butyl, hexyl, octyl, cyclohexyl, 4-methoxyphenyl, 4-chlorophenyl, 3,4-dichlorophenyl, benzyl, 4-methoxybenzyl, 4-chlorobenzyl, 3,4-dichlorobenzyl, phenethyl, 2-(4-methoxyphenyl)ethyl, 2-(4-chlorophenyl)ethyl, 2-(3,4-dichlorophenyl)ethyl, hydroxymethyl, chloromethyl and chloropropyl.

In one such aspect, the R¹ substituents in the compound of formula (I) denotes hydrogen, optionally substituted C₁-C₁₈ alkyl, optionally substituted aralkyl having up to 10 carbon atoms, or optionally substituted aryl having up to 10 carbon atoms. In a further aspect, R¹ denotes hydrogen or optionally substituted C₁-C₁₈ alkyl. Additionally or alternatively, R¹ is hydrogen or C₁-C₈ alkyl, with hydrogen, methyl, butyl and octyl being the most preferred R¹ substituents.

Thus, in one aspect, isothiazolinones used in the biocidal composition according to the present disclosure are those represented by the general Formula (I) above, where R¹ denotes hydrogen or C₁-C₈ alkyl, and R² and R³ independently denote chloro or hydrogen, or together R² and R³ may provide a 1,2 benzisothiazolin-3-one group.

In one aspect, isothiazolinones used in the preservative composition according to the present disclosure are those represented by the general Formula (I) above, where R¹ denotes hydrogen, methyl, butyl or octyl, and R² and R³ independently denote chloro or hydrogen, or together R² and R³ may provide a 1,2 benzisothiazolin-3-one group.

Furthermore, as discussed above, in one aspect, the isothiazolinone of Formula (I) is a benzisothiazolinone of Formula (II):

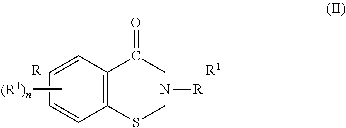

where, R is hydroxy, halogen (especially chlorine), C₁₋₄-alkyl or C₁₋₄-alkoxy;
R¹ is as hereinbefore defined; and n is from 0 to 4.
R, when present in an aspect, is located in one or both of the 5 and 6 positions of the phenyl ring of the benzisothiazolinone. However, in a further aspect, n is zero.

In one aspect, a benzisothiazolinone of Formula (II) are those in which R¹ is H or C₁₋₅-alkyl, or where R¹ is H or C₃₋₅-alkyl. Examples of compounds of the Formula (II) include, for example 1,2-benzisothiazolin-3-one, N-n-butyl-, N-methyl-, N-ethyl-, N-n-propyl-, N-isopropyl-, N-n-pentyl-, N-cyclopropyl-, N-isobutyl-, and N-tert-butyl-1,2-benzisothiazolin-3-one. Thus, in one aspect, the benzisothiazolinone of Formula (I) is 1,2-benzisothiazolin-3-one.

For instance, in one aspect, isothiazolones include, but are not limited to, methylisothiazol-3-one (MIT), 5-chloro-2-methyl-4-isothiazolin-3-one (CMIT), 4,5-dichloro-2-n-octyl-4-isothiazolin-3-one (DCOIT), octylisothiazol-3-one (OIT), 1,2-benzisothiazol-3(2H)-one (BIT), N-methyl-1,2-benzisothiazol-3-one (MBIT) and N-(n-butyl)-1,2-benzisothiazol-3-one (BBIT). Particularly preferred isothiazolones include, but are not limited to, methylisothiazol-3-one (MIT), 5-chloro-2-methyl-4-isothiazolin-3-one (CMIT), octylisothiazol-3-one (OIT), 1,2-benzisothiazol-3(2H)-one (BIT), N-methyl-1,2-benzisothiazol-3-one (MBIT) and N-(n-butyl)-1,2-benzisothiazol-3-one (BBIT). Even more preferred isothiazol-3-ones are 5-chloro-2-methyl-4-isothiazolin-3-one (CMIT), octylisothiazolone (OIT), 1,2-benzisothiazol-3(2H)-one (BIT) and N-(n-butyl)-1,2-benzisothiazol-3-one (BBIT), more preferably octylisothiazolone (OIT), 1,2-benzisothiazol-3(2H)-one (BIT) and N-(n-butyl)-1,2-benzisothiazol-3-one (BBIT), or combinations thereof.

In one aspect, the formulation may include a pyrithione compound. For instance, pyrithione compounds can include sodium pyrithione, zinc pyrithione, copper pyrithione, 1-hydroxy-2-pyridinone and pyrithione disulfide and mixtures thereof.

Nonetheless, when present, the further organic fungicidal preservative can be present in amounts of about 10% or less, such as about 9% or less, such as about 8% or less, such as about 7% or less, such as about 6% or less, such as about 5% or less, such as about 4% or less, such as about 3% or less, such as about 2% or less, such as about 1% or less, such as about 0.5% or less by weight of the formulation. However, as discussed above, it should be understood that the preservative formulation may also be generally free of any one, or combination of further organic fungicidal preservatives due to the unexpected synergism of the preservative composition of the present disclosure.

Furthermore, in one aspect, the preservative composition may include a solvent, a surfactant, a diluent, an emulsifier, or a combination thereof.

For instance, in one aspect, the above referenced amounts and ratios correspond to a preservative composition that can be considered to be a concentrate. The preservative composition, regardless of whether the preservative composition is present as a concentrate can include a solvent, a surfactant, or a combination thereof, present in the preservative composition in an amount sufficient to stabilize and maintain the above discussed “active” components in their dispersed or solubilized form.

Particularly, the preservative composition may be considered to be a concentrate present in the form of a liquid composition. However, it should be understood that, in one aspect, no solvent is present, and the preservative composition may be a solid implant or paste. However, in one aspect, the preservative composition is in the form of an emulsion made up of solubilized liquid droplets. Preferably, the emulsions are in the form of a micro-emulsion. The person skilled in the art of making emulsions knows how to make an emulsion according to the invention by the use of suitable solvents and emulsifying agents.

In one aspect, the preservative composition is an aqueous solution, but one or more organic solvents or a mixture of water and an organic solvent could also be used. Suitable organic solvents include both aromatic and aliphatic hydrocarbon solvents such as white spirit, petroleum distillate, kerosene, diesel oils and naphthas. Also, glycol ethers, benzyl alcohol, 2-phenoxy ethanol, methyl carbitol, propylene carbonate, benzyl benzoate, ethyl lactate and 2-ethyl hexyl lactate may be used alone, or in combination with water.

When present in the preservative composition, the solvent may be present in an amount from about 0.1% to about 85% by weight, such as about 2% to about 80%, such as about 3% to about 75%, such as about 4% to about 70%, such as about 5% to about 65%, such as about 6% to about 60%, such as about 7% to about 55%, such as about 8% to about 50%, such as about 9% to about 45%, such as about 10% to about 40% by weight, or any ranges or values therebetween. Of course, as noted above, in one aspect, the preservative composition in the form of a concentrate may be generally free of solvent, and thus may be in the form of a solid or paste.

For instance, in one aspect, the preservative composition includes from about 1% to about 50% by weight copper containing biocide, from about 0.1% to about 50% by weight zinc containing biocide, from about 0.1% to about 75% by weight boric acid, about 0.1% to about 20% by weight azole, and the balance solvent, surfactant, emulsifier, optional components (including a further organic fungicidal preservative) or combinations thereof.

Furthermore, in an aspect, the preservative composition includes from about 5% to about 32.5% by weight copper containing biocide, from about 0.75% to about 32.5% by weight zinc containing biocide, from about 0.75% to about 32.5% by weight boric acid, from about 0.5% to about 15% by weight azole, and the balance solvent, surfactant, emulsifier, optional components (including a further organic fungicidal preservative) or combinations thereof.

Additionally or alternatively, in one aspect, the preservative composition includes from about 7.5% to about 27.5% by weight copper containing biocide, from about 1.5% to about 27.5% by weight zinc containing biocide, from about 1.5% to about 52.5% by weight boric acid, about 0.9% to about 12.5% by weight azole, and the balance solvent, surfactant, emulsifier, optional components (including a further organic fungicidal preservative) or combinations thereof.

Nonetheless, in one aspect, the preservative composition may be diluted prior to use with one or more diluents. The diluent may be a further amount of the one or more solvents discussed above, or may be an alternative diluent as known in the art. Regardless, the diluent may be added to the preservative composition at a ratio of diluent to preservative composition of about 200:1 to about 1:1, such as about 100:1 to about 1:1, such as about 75:1 to about 2:1, such as about 50:1 to about 3:1, such as about 40:1 to about 4:1, such as about 20:1 to about 5:1, or any ranges or values therebetween. Thus, in one aspect, the preservative composition is present in the ready to use formulation in an amount of about 20 wt. % or less, such as about 15 wt. % or less, such as about 10 wt. % or less, such as about 7.5 wt. % or less, such as about 5 wt. % or less, such as about 2.5 wt. % or less, such as about 2 wt. % or less, such as about 1.5 wt. % or less, such as about 1 wt. % or less, or any ranges or values therebetween.

Stated in an alternative fashion, the diluent may be present in an amount such that copper ions are present in a ready to use formulation (e.g. diluted preservative formulation) in an amount of about 1% or less by weight, such as about 0.5% or less, such as about 0.1% or less, such as about 750 ppm or less, such as about 500 ppm or less, such as about 400 ppm or less, or any ranges or values therebetween. Similarly, zinc ions may be present in the ready to use formulation in an amount of about 1% by weight or less, such as about 0.5% or less, such as about 0.1% or less, such as about 750 ppm or less, such as about 500 ppm or less, such as about 400 ppm or less, such as about 200 ppm or less, such as about 100 ppm or less, or any values or ranges therebetween. Boron ions may be present in the ready to use formulation in an amount of about 1% by weight or less, such as about 0.5% or less, such as about 0.1% or less, such as about 750 ppm or less, such as about 500 ppm or less, such as about 400 ppm or less, such as about 200 ppm or less, such as about 100 ppm or less, or any values or ranges therebetween. Additionally or alternatively, an azole or azoles may be present in the ready to use formulation in an amount of about 1% by weight or less, such as about 0.5% or less, such as about 0.1% or less, such as about 750 ppm or less, such as about 500 ppm or less, such as about 400 ppm or less, such as about 200 ppm or less, such as about 100 ppm or less, such as about 50 ppm or less, such as about 5 ppm or less, or any values or ranges therebetween.

In one aspect, the preservative composition, or the ready to use formulation can have a pH of about 3 to about 10, such as about 3.5 to about 9.5, such as about 4 to about 9, such as about 4.5 to about 8.5, such as about 5 to about 8, or any ranges or values therebetween. However, in one aspect, the above pH values refer to a pH of a preservative composition. Furthermore, in an aspect, the ready to use formulation can have a pH of about 4 to about 11, such as about 4.5 to about 10.5, such as about 5 to about 10, such as about 5.5 to about 9.5, such as about 6 to about 9, or any ranges or values therebetween. As known in the art, pH builders, pH buffers, and other pH adjusting agents may be used to obtain and stabilize the above pH values.

In one aspect, the preservative formulation is used to treat a cellulosic or wood based substrate. In one aspect, cellulosic materials which can be treated with a preservative composition of the present disclosure include lignocellulosic substrates, wood plastic composites, cardboard and cardboard faced building products such as plasterboard, and cellulosic material, such as cotton. Also, leather, textile materials and even synthetic fibers, hessian, rope, and cordage as well as composite wood materials. For convenience, the present disclosure is described with reference to the treatment of wood but it will be appreciated that other cellulosic materials may be treated analogously. However, in one aspect, though not exclusively, the preservative composition is applied to sawn timber, logs or laminated veneer lumber, OSB, or MDF. In one aspect, the substrate is wood or a wood composite material which is intended to become wet during its life, for example, wood for window frames, timber used above ground in exposed environments, such as decking and timber used in ground contact or fresh water environments

In one aspect, a treated cellulosic or wood based substrate may be treated with an amount of the preservative formulation (or ready to use formulation) such that the treated cellulosic or wood based substrate includes from about 150 grams per meter cubed (g/m³) to about 7.5 kg/m³ copper, such as about 200 g/m³ to about 6 kg/m³ copper, about 40 g/m³ to about 2 kg/m³ zinc, such as about 200 g/m³ to about 1.5 kg/m³ zinc, about 20 g/m³ to about 3.5 kg/m³ boric acid equivalents, such as about 40 g/m³ to about 3 kg/m³ boric acid equivalents, about 10 g/m³ to about 300 g/m³ azole, such as about 20 g/m³ to about 260 g/m³ azole, or a combination thereof. For instance, as shown in the examples, the present disclosure has found that the preservative formulation is able to penetrate even to the core of the cellulosic or wood based product, and evenly distribute the preservative.

However, in an aspect, a wood or cellulosic based substrate may be treated with a ready to use preservative composition of the present disclosure. In such an aspect, the wood or cellulosic based substrate may contain the copper containing biocide, zinc containing biocide, boric acid, and tebuconazole in the amounts discussed above in regards to the ready to use composition.

Nonetheless, in one aspect, the present disclosure is further directed to a method of forming a preservative composition as well as treating a wood based substrate with the preservative composition. For instance, in one aspect, the copper containing biocide and the azole may be micronized (e.g. decreased in size from larger than micron size to the above discussed sizes/particle size distribution), together, or can instead be micronized separately and then combined, either alone, or in combination with one or more dispersants/complexing agents. Furthermore, in one aspect, the azole, copper containing biocide, zinc containing biocide, and boron containing biocide may be pre-mixed as discussed above, however, it should be understood that, in some aspects, the preservative composition may be present in a multi-part form and mixed shortly before treating the wood or cellulose based substrate. However, in an aspect, the preservative composition is in one-part form, such as a pack or mix, and contains each of the azole, copper containing biocide, zinc containing biocide, and boron containing biocide, in the amounts discussed above.

Regardless of the form of the preservative composition, in one aspect is diluted as discussed above, and used to treat a wood or cellulose based substrate. For instance, in one aspect, the application of the preservative composition of the present disclosure to the wood or cellulose based substrate may be by one or more of dipping, deluging, spraying, brushing, or other surface coating means or by impregnation methods, e.g., high pressure or double vacuum impregnation into the body of the wood or other material. In one aspect, the method is impregnation under pressure.

Various boron containing compounds can contain different levels of boron. In light of this, when comparing boron containing compounds, it may be helpful to convert amounts of one boron containing compound to an equivalent amount, by boron content, of another boron containing compound. In the following examples, boric acid equivalent was calculated using the following conversion factors:

| | | | | | Disodium | |
|---|---|---|---|---|---|---|
| | | | Boric | | Octaborate | Zinc |
| | Boron | B₂O₃ | Acid | Borax | Tetrahydrate | Borate |
| | Equivalent | Equivalent | Equivalent | Equivalent | Equivalent | Equivalent |
| Boron | 1.000 | 3.221 | 5.721 | 8.850 | 4.771 | 6.711 |
| B₂O₃ | 0.311 | 1.000 | 1.776 | 2.748 | 1.481 | 2.084 |
| Boric Acid | 0.175 | 0.563 | 1.000 | 1.547 | 0.834 | 1.173 |
| Borax | 0.113 | 0.364 | 0.646 | 1.000 | 0.539 | 0.758 |
| Disodium | 0.210 | 0.675 | 1.199 | 1.855 | 1.000 | 1.407 |
| Octaborate | | | | | | |
| Tetrahydrate | | | | | | |
| Zinc Borate | 0.149 | 0.480 | 0.852 | 1.319 | 0.711 | 1.000 |

For example, if zinc borate is retained in a wood block at a concentration of 1,000 ppm, the boric acid equivalent is 1,000 ppm*0.852=852 ppm.

Furthermore, certain aspects of the present disclosure may be better understood according to the following examples, which are intended to be non-limiting and exemplary in nature.

### EXAMPLES

It will be understood that the preservative compositions described in the Examples may be substantially free of any substance not expressly described.

Abbreviations

| | |
|---|---|
| AWPA | American Wood Protection Association (AWPA) |
| BAE | Boric acid equivalent |
| BCC | Basic copper carbonate |
| SYP | Southern yellow pine |

Methods—AWPA E10-16: “Laboratory Method for Evaluating the Decay Resistance of Wood-Based Materials Against Pure Basidiomycete Cultures: Soil/Block Test.” This method is a screening test to determine the resistance of wood-based materials to decay by selected fungi under controlled laboratory conditions. It can also be used to establish the minimum amount of preservative that is effective in preventing decay of selected species of wood by selected fungi under optimum laboratory conditions. This test method is intended to provide information for standardization of protection treatments. Blocks of wood are first conditioned via vacuum impregnation with a preservative solution. Typically, the blocks are submerged in the treating solution then exposed to vacuum treatment (30 min at 100 mmHg) followed by pressure treatment (60 min at 700 kPa) and 30 minutes at atmospheric pressure. Test blocks should be cubes milled as accurately as possible to 14 mm or 19 mm, which yields a nominal volume of 2.7 cm³ or 6.9 cm³, respectively. After conditioning, the blocks of wood are exposed to wood-destroying fungi.

Particle size: The particle size was analyzed by Horiba LA-910 Particle Size Distribution Analyzer (PSDA).

### Example 1—AWPA E10-16 Soil/block Test

Wood species: southern yellow pine (SYP).

Microorganisms: The following organisms are used in this study: Fibroporia radiculosa and Fomitopsis palustri. Fibroporia radiculosa (basidiomycete) and Fomitopsis palustri (basidiomycete) are brown rot fungi that have been documented to cause premature failure of wooden stakes treated with copper-based wood preservatives in the field, due to copper-tolerance.

Particle size: The particle size of the BCC, tebuconazole, zinc oxide was analyzed by Horiba LA-910 Particle Size Distribution Analyzer (PSDA). The average particle size of BCC, tebuconazole and zinc oxide was from 0.15 to 0.5 microns, with a D50 of 0.35 and a D95 of less than 1 micron.

The soil block test was conducted following the procedure as described in AWPA E10-16. The test was performed on wood blocks treated via vacuum impregnation with a wood preservative composition of the present invention before and after leaching with above mentioned microorganisms.

The nature and ratio of the wood preservative composition is summarized in Table 1. The ratio is expressed as weight % based on the total weight of the wood preservative composition. The leaching protocol was conducted following the procedure described in AWPA E10-16.

TABLE 1
Ratio of copper compound to active components in wood
preservative composition in weight % based on the
total weight of the wood preservative composition.

| Example | BCC:tebuconazole | BCC:ZnO | BCC:boric acid |
|---|---|---|---|
| 0 | 25:1 | | |
| 15 | 25:1 | | 0 |
| 17 | 25:1 | 6.7:1 | 2.4:1 |
| 18 | 25:1 | 13.4:1 | 4.7:1 |
| 22 | 0 | 0 | 0 |

Loss of mass of the wood block indicates the failure of a particular wood preservative composition to protect the wood against fungal attack. The retention level of a particular preservative corresponds to the minimum amount of preservative that protects the wood block against fungal decay. Calculation of Retentions was according to AWPA E10-16. The resulting weight loss data are summarized in Tables 2.

TABLE 2
AWPA E10-16, Results retention and average weight loss that compare leached blocks to blocks not leached.

| | Total | Component Retention | | | | Leached | | Not Leached | |
|---|---|---|---|---|---|---|---|---|---|
| | wood | in wood block | | | | F. | F. | F. | F. |
| | preservative | Retained | Tebuconazoel | Zinc | Boric acid | radiculosa | palustris | radiculosa | palustris |
| | composition | copper | retained | retained | retained | weight | Weight | weight | Weight |
| Example | [kg/m³] | [kg/m³] | [kg/m³] | [kg/m³] | [kg/m³] | loss [%] | loss [%] | loss [%] | loss [%] |
| 0 | 2.24 | 2.15 | 0.088 | | | | | 39.6 | |
| 15 | 2.40 | 2.31 | 0.092 | | | 47.1 | 23.9 | | |
| 15 | 3.36 | 3.23 | 0.129 | | | 49.0 | 23.5 | | |
| 17 | 3.71 | 2.31 | 0.092 | 0.345 | 0.963 | 45.8 | 13.1 | −1.2 | 15.8 |
| 17 | 5.19 | 3.23 | 0.129 | 0.482 | 1.35 | 41.9 | 15.8 | −1.1 | 19.0 |
| 18 | 3.15 | 2.31 | 0.092 | 0.172 | 0.578 | 44.1 | 17.8 | −1.7 | 28.7 |
| 18 | 4.29 | 3.23 | 0.129 | 0.241 | 0.687 | 35.4 | 14.3 | −1.7 | 23.9 |
| 22 | 0 | | | | | | | 52.5 | 41.5 |

In this test, both F. radiculosa and F. palustris were very active as indicated by untreated control average weight losses of 52.5% and 41.5% respectively. The wood preservative composition of the present invention proves to be highly efficient in protecting the impregnated blocks against decay by the given test fungus.

These and other modifications and variations to the present invention may be practiced by those of ordinary skill in the art, without departing from the spirit and scope of the present invention, which is more particularly set forth in the appended claims. In addition, it should be understood that aspects of the various aspects may be interchanged both in whole or in part. Furthermore, those of ordinary skill in the art will appreciate that the foregoing description is by way of example only, and is not intended to limit the invention so further described in such appended claims.

1. A wood preservative composition comprising:
(a) a copper containing biocide;
(b) a zinc containing biocide;
(c) a boron containing biocide comprising boric acid, disodium tetraborate pentahydrate, disodium octoborate tetrahydrate, or combinations thereof; and
(d) an azole,
wherein the copper containing biocide and the zinc containing biocide are present in the wood preservative composition such that a ratio of copper ions to zinc ions is from about 15:1 to about 1:5; and
wherein the copper containing biocide and the boron containing biocide are present in the wood preservative composition such that a ratio of copper ions to boric acid equivalents is from about 15:1 to about 1:5.

2. The wood preservative composition of claim 1, wherein the copper containing biocide comprises a basic copper carbonate, a copper oxide, or a combination thereof.

3. The wood preservative composition of claim 1, wherein the zinc containing biocide comprises a zinc oxide or a combination of zinc oxide and zinc borate.

4. (canceled)

5. The wood preservative composition of claim 1, wherein the azole comprises a tebuconazole, penflufen, or a mixture thereof.

6. The wood preservative composition of claim 1, wherein the azole comprises a tebuconazole, a propiconazole, or a mixture thereof.

7. The wood preservative composition of claim 1, wherein the azole is complexed with the copper containing biocide.

8. The wood preservative composition of claim 1, wherein the azole comprises micronized azole particles, wherein 50% or more of the micronized azole particles have a particle size of less than about 1 micron.

9. The wood preservative composition of claim 1, wherein the copper containing biocide comprises a basic copper carbonate; wherein the zinc containing biocide comprises a zinc oxide or a combination of a zinc oxide and zinc borate; wherein the boron containing biocide comprises a boric acid; and wherein the azole comprises a tebuconazole.

10. The wood preservative composition of claim 1, wherein the copper containing biocide constitutes from about 0.1 wt. % to about 75 wt. % of the composition; wherein the zinc containing biocide constitutes from about 0.1 wt. % to about 50 wt. % of the composition; wherein the boron containing biocide constitutes from about 0.1 wt. % to about 75 wt. % of the composition; and the azole constitutes from about 0.1 wt. % to about 20 wt. % of the composition.

11. (canceled)

12. The wood preservative composition of claim 1, wherein the composition further comprises an alkanolamine.

13. The wood preservative composition of claim 1, wherein the copper containing biocide and the zinc containing biocide are present in the wood preservative composition such that a ratio of copper ions to zinc ions is from about 10:1 to about 2:1.

14. The wood preservative composition of claim 1, wherein the copper containing biocide and the boron containing biocide are present in the wood preservative composition such that a ratio of copper ions to boric acid equivalents is from about 10:1 to about 2:1.

15. The wood preservative composition of claim 1, wherein the zinc containing biocide and the boron containing biocide are present in the wood preservative composition such that a ratio of zinc ions to boric acid equivalents is from about 5:1 to about 1:5.

16. (canceled)

17. A wood based product treated with the wood preservative composition of claim 1.

18. The wood based product of claim 17, wherein the copper ions are present in the wood based product in an amount from about 200 grams per meter cubed (g/m³) to about 7.5 kg/m³; the zinc ions are present in the wood based product in an amount from about 40 g/m³ to about 1.5 kg/m³; the boric acid equivalents are present in the wood based product in an amount from about 40 g/m³ to about 3 kg/m³; and the azole is present in the wood based product in an amount from about 20 g/m³ to about 280 g/m³ of the product.

19. A wood preservative composition comprising:
(a) a copper containing biocide;
(b) a zinc containing biocide;
(c) a boron containing biocide comprising boric acid; and
(d) an azole;
wherein the copper containing biocide and the zinc containing biocide are present in the wood preservative composition such that a ratio of copper ions to zinc ions is from about 15:1 to about 3:1;
wherein the copper containing biocide and the boron containing biocide are present in the wood preservative composition such that a ratio of copper ions to boric acid equivalents is from about 15:1 to about 1:1;
wherein the copper containing biocide comprises a basic copper carbonate; wherein the zinc containing biocide comprises a zinc oxide or a combination of a zinc oxide and zinc borate;
wherein the boron containing biocide comprises a boric acid; and wherein the azole comprises a tebuconazole.

20. A method of treating wood with the wood preservative composition of claim 1, wherein the copper containing biocide, the zinc containing biocide, the boron containing biocide, and the azole are injected into the wood in a one-step process.

21. A method for manufacturing a wood preservative composition, the method comprising:
(a) dispersing at least a portion of a copper containing biocide and a zinc containing biocide;
(b) micronizing at least one azole to produce a micronized azole; and
(c) combining a boron containing biocide comprising boric acid with the copper containing biocide, the zinc containing biocide, and the micronized azole;
wherein the copper containing biocide and the zinc containing biocide are present in the wood preservative composition such that a ratio of copper ions to zinc ions is from about 15:1 to about 1:5, and
wherein the copper containing biocide and the boron containing biocide are present in the wood preservative composition such that a ratio of copper ions to boric acid equivalents is from about 15:1 to about 1:5.

22. The method of claim 21, the method further comprising milling the copper containing biocide and the zinc containing biocide with at least one dispersant.

23. (canceled)

24. The method of claim 21, wherein the copper containing biocide comprises a basic copper carbonate; wherein the zinc containing biocide comprises a zinc oxide or a combination of a zinc oxide and a zinc borate; wherein the boron containing biocide comprises a boric acid; and the azole comprises a tebuconazole.
